(19) United States
(12) Patent Application Publication
(10) Pub. No.: US 2024/0248588 A1
(43) Pub. Date: Jul. 25, 2024

(54) MEDIA CONTENT CREATION METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Ying YE, Shenzhen (CN); Yang LI, Shenzhen (CN); Lijing YUAN, Shenzhen (CN); Licheng ZHENG, Shenzhen (CN); Rui WANG, Shenzhen (CN); Jingyi ZHOU, Shenzhen (CN); Jingjing LIU, Shenzhen (CN); Ni SU, Shenzhen (CN); Yuyang KUANG, Shenzhen (CN)

(21) Appl. No.: 18/624,698

(22) Filed: Apr. 2, 2024

Related U.S. Application Data
(63) Continuation of application No. PCT/CN2023/111082, filed on Aug. 3, 2023.

(30) Foreign Application Priority Data
Sep. 2, 2022 (CN) 202211074165.4

(51) Int. Cl. G06F 3/0484; G06F 3/04817; G06F 40/186

(52) U.S. Cl. CPC G06F 3/0484; G06F 3/04817; G06F 40/186

(57) ABSTRACT

A media content creation method includes: displaying, by a terminal device, a main modality editing interface; generating, by the terminal device, main modality media content in response to an editing operation performed on the main modality editing interface; converting, by the terminal device, the main modality media content to target sub-modality media content in response to a modality conversion operation; and displaying, by the terminal device, the generated main modality media content and the target sub-modality media content.

### CROSS REFERENCES TO RELATED APPLICATIONS

This application is a continuation application of PCT patent application PCT/CN2023/111082, filed on Aug. 3, 2023, which claims priority to Chinese Patent Application No. 202211074165.4, filed with the China National Intellectual Property Administration on Sep. 2, 2022 and entitled “MEDIA CONTENT CREATION METHOD AND APPARATUS, DEVICE, AND STORAGE MEDIUM”, both of which are incorporated herein by reference in their entirety.

### FIELD OF THE TECHNOLOGY

Embodiments of this application relate to the field of multimedia technologies, and in particular, to a media content creation method and apparatus, a device, and a storage medium.

### BACKGROUND

With the rapid development of multimedia technologies, media content of various modalities is disseminated on social media. Social media platforms support different media modalities. For example, some media platforms support videos, some media platforms support presentations, some media platforms support images, and certainly, some media platforms support a plurality of media modalities such as videos, presentations, and images. Therefore, to satisfy requirements of different media platforms, a media content creator usually needs to create the same content a plurality of times for different media modalities, which may increase a workload of the media content creator and reduce creation efficiency of the media content.

### SUMMARY

Embodiments of this application provide a media content creation method and apparatus, a device, and a storage medium, to reduce a workload of a media content creator and improves creation efficiency of media content.

According to a first aspect, an embodiment of this application provides a media content creation method, applied to a terminal device, the method including: displaying a main modality editing interface; generating main modality media content in response to an editing operation performed on the main modality editing interface; converting the main modality media content to target sub-modality media content in response to a modality conversion operation; and displaying the generated main modality media content and the target sub-modality media content.

According to a second aspect, an embodiment of this application provides a media content creation apparatus, applied to a terminal device, the apparatus including: a first display unit, configured to display a main modality editing interface; a processing unit, configured to generate main modality media content in response to an editing operation performed on the main modality editing interface; a conversion unit, configured to convert the main modality media content to target sub-modality media content in response to a modality conversion operation; and a second display unit, configured to display the generated main modality media content and the target sub-modality media content.

According to a third aspect, an embodiment of this application provides an electronic device, including: at least one memory and at least one processor, the at least one memory being configured to store a computer program, and the at least one processor being configured to invoke and run the computer program stored in the at least one memory to perform the method in the first aspect.

According to a fourth aspect, an embodiment of this application provides a non-transitory computer-readable storage medium, configured to store a computer program, the computer program causing a computer to perform the method in the first aspect.

According to a fifth aspect, an embodiment of this application provides a chip, configured to implement the method in any implementation in the first aspect or various implementations thereof. Specifically, the chip includes: a processor, configured to invoke and run a computer program from a memory, to cause a device installed with the chip to perform the method in any implementation in the first aspect or various implementations thereof.

Based on the above, in this application, the terminal device displays the main modality editing interface in response to the triggering operation, the terminal device generates the main modality media content in response to the editing operation performed on the main modality editing interface, the terminal device converts the main modality media content to the target sub-modality media content in response to the modality conversion operation, and the terminal device displays the generated main modality media content and the target sub-modality media content. In other words, in the embodiments of this application, conversion among a plurality of pieces of modality media content is supported. A media content creator may convert the main modality media content to at least one piece of sub-modality media content different from the main modality media content by inputting the modality conversion operation after creating the main modality media content by using an application. The whole modality conversion process is performed by the application based on a modality conversion algorithm thereof, without participation of the media content creator, thereby reducing a workload of the media content creator, and improving creation efficiency of the media content.

### BRIEF DESCRIPTION OF THE DRAWINGS

To describe the technical solutions in embodiments of the present disclosure more clearly, the following briefly describes the accompanying drawings required for describing the embodiments. Apparently, the accompanying drawings in the following description show merely some embodiments of the present disclosure.

FIG. 1 is a schematic diagram of an application scenario according to an embodiment of this application.

FIG. 2 is a flowchart of a media content creation method according to an embodiment of this application.

FIG. 3 is a schematic diagram of an interface according to an embodiment of this application.

FIG. 4 is a schematic diagram of another interface according to an embodiment of this application.

FIG. 5 is a schematic diagram of a generated main modality media content interface.

FIG. 6A to FIG. 6D are schematic diagrams of a main modality and a corresponding sub-modality.

FIG. 7A to FIG. 7C are schematic diagrams of a conversion process of converting a main modality to a sub-modality.

FIG. 8A to FIG. 8F are schematic diagrams of another conversion process of converting a main modality to a sub-modality.

FIG. 9 is a schematic flowchart of a media content creation method according to an embodiment of this application.

FIG. 10 is a schematic diagram of interaction between a creation application and a media content creator and within the creation application according to an embodiment of this application.

FIG. 11 is a schematic structural diagram of a media content creation apparatus according to an embodiment of this application.

FIG. 12 is a schematic block diagram of an electronic device according to an embodiment of this application.

### DESCRIPTION OF EMBODIMENTS

Technical solutions in embodiments of the present disclosure are clearly and completely described below with reference to accompanying drawings in the embodiments of the present disclosure. Apparently, the described embodiments are merely some rather than all of the embodiments of the present disclosure. Based on the embodiments of the present disclosure, all other embodiments obtained by a person of ordinary skill in the art without creative efforts fall within the protection scope of the present disclosure.

Terms “first”, “second”, and the like in the specification, the claims, and the above accompanying drawings of the present disclosure are intended to distinguish between similar objects, and are not necessarily used to describe a specific order or sequence. It is to be understood that data used in this way is exchangeable in a proper case, so that the embodiments of the present disclosure described herein can be implemented in another order other than those shown or described herein. Moreover, terms “include” and “have” and any of their variations are intended to cover non-exclusive inclusion. For example, a process, a method, a system, a product, or a server that includes a list of steps or units is not necessarily limited to those expressly listed steps or units, but may include other steps or units not expressly listed or inherent to such the process, the method, the product, or a device.

For ease of understanding of the embodiments of this application, related concepts involved in the embodiments of this application are first described.

Meta-creation: In the embodiments of this application, the meta-creation is a creation mode that takes posting objectives such as a video, audio, graphics, and presentations into consideration in a creation process. Because a plurality of media modalities are involved, the meta-creation in the embodiments of this application may also be referred to as multi-modality creation.

Meta-creation project: In the embodiments of this application, a meta-creation project is a meta-creation project composed of customized structured data files combined with corresponding accessible multimedia material files. The meta-creation project includes metadata that describes a project structure, and also includes accessible paths of all material media files that are referenced. The metadata that describes the project structure may be understood as a media material involved in current modality media content.

Main modality and sub-modality: A feature of the meta-creation project is to distinguish between the main modality and the sub-modality. One original creation project in the embodiments of this application supports one main modality and a plurality of sub-modalities. Media forms of the sub-modalities are not duplicates of that of the main modality. For example, the main modality is a project file of a video, and sub-modalities of the video are presentations, audio, and pictures.

Intelligent modality conversion: It supports mutual conversion between a meta-creation project and a modality, and provides a standardized modality conversion rule by providing conversion algorithm logics for a plurality of types of modalities.

An application programming interface (APIs for short) is a set of predefined functions intended to provide an application and a developer with the ability to access a set of processes based on specific software or hardware, without directly accessing source code or deeply understanding details of an internal working mechanism.

A software development kit (SDK for short) is a collection of related documents, demonstration examples, and some tools to assist in development of a specific type of software.

The media content creation method involved in the embodiments of this application may further be combined with the cloud technology, for example, combined with cloud storage in the cloud technology, to store generated media content in the cloud. The related content of the cloud technology is described below.

The cloud technology is a hosting technology that unifies a series of resources such as hardware, software, and a network in a wide area network or a local area network to implement computing, storage, processing, and sharing of data.

Cloud computing is a computing mode, which distributes computing tasks on a resource pool composed of a large quantity of computers, so that various application systems can obtain computing power, storage space, and information services as required. A network that provides resources is referred to as “cloud”. Resources in the cloud seem to users to be infinitely expandable, readily accessible, available for on-demand usage, readily expandable, and payable based on usage.

Cloud storage is a new concept extended and developed based on the concept of cloud computing. A distributed cloud storage system (which is referred to as a storage system for short below) is a storage system that integrates, by using functions such as a cluster application, a grid technology, and a distributed storage file system, a large quantity of different types of storage devices (the storage devices are also referred to as storage nodes) in a network through application software or application interfaces to operate collaboratively, to jointly provide data storage and service access functions to the outside.

A schematic diagram of an application scenario according to an embodiment of this application is described below.

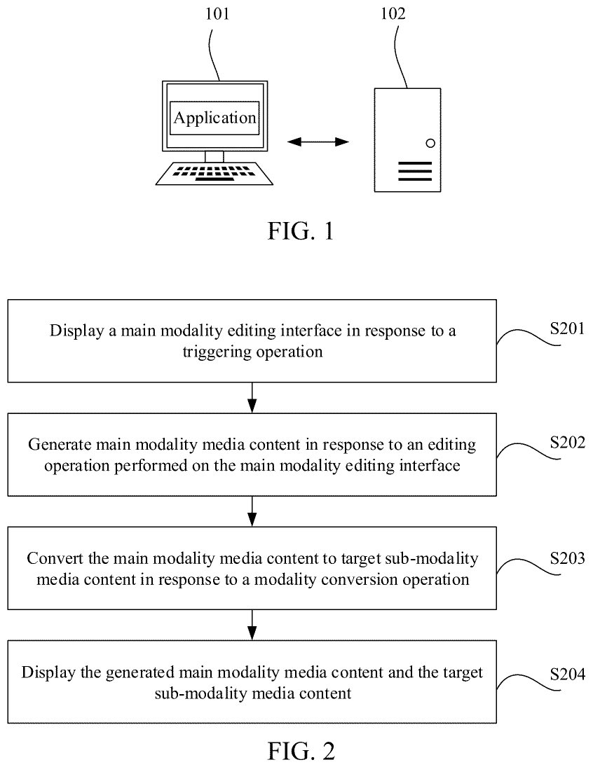

FIG. 1 is a schematic diagram of an application scenario according to an embodiment of this application. As shown in FIG. 1, the application scenario includes a terminal device 101 and a server 102.

The terminal device 101 includes but is not limited to a desktop computer, a notebook computer, a smartphone, a tablet computer, an Internet of Things device, a portable wearable device, and the like. The Internet of Things device may be a smart speaker, a smart television, a smart air conditioner, a smart onboard device, and the like. The portable wearable device may be a smartwatch, a smart bracelet, a head-mounted device, and the like. The terminal device 101 is often equipped with a display apparatus. The display apparatus may alternatively be a display, a display screen, a touchscreen, and the like. The touchscreen may alternatively be a touch screen, a touch panel, and the like.

One or more servers 102 may be equipped. When a plurality of servers 102 are equipped, at least two servers configured to provide different services exist, and/or at least two servers configured to provide the same service exist, for example, provide the same service in a load balancing manner, which is not limited in this embodiment of this application. The foregoing server 102 may be an independent physical server, or may be a server cluster formed by a plurality of physical servers or a distributed system, and may further be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The server 102 may alternatively become a node of a blockchain.

The terminal device 101 may be directly or indirectly connected to the server 102 through wired or wireless communication, which is not limited in this application.

An application for media content creation is installed on the terminal device 101 in this embodiment of this application. A media content creator triggers an application icon on a desktop of the terminal device 101 to start the application. After the application is started, a meta-creation creating option is displayed. After the media content creator triggers the meta-creation creating option, the application displays a creation container by using the terminal device 101. The media content creator may perform creation in the creation container, and then generate main modality media content. Next, the media content creator may input a modality conversion operation into the application. The application converts the generated main modality media content to target sub-modality media content in response to the modality conversion operation inputted by the media content creator, and displays the generated main modality media content and the target sub-modality media content in the creation container for reference by the media content creator.

Further, the application may transmit the generated main modality media content and/or the target sub-modality media content to the server by using the terminal device 101, to implement content storage or posting.

The application scenario in this embodiment of this application includes but is not limited to that shown in FIG. 1.

Social media platforms support different media modalities. For example, some media platforms support videos, some media platforms support presentations, some media platforms support images, and certainly, some media platforms support a plurality of media modalities such as videos, presentations, and images. Therefore, to satisfy requirements of different media platforms, the media content creator usually needs to create the same content a plurality of times, for example, respectively create media content of different modalities by using media tools corresponding to different modalities, which increases a workload of the media content creator and reduces creation efficiency of the media content.

To resolve the foregoing technical problem, this embodiment of this application provides a media content creation method, to support conversion among a plurality of pieces of modality media content, for example, support conversion from a video modality to a picture modality, a presentation modality, or an audio modality, support conversion from the picture modality to a video modality, the presentation modality, or the audio modality, support conversion from the presentation modality to the video modality, the picture modality, or the audio modality, and support conversion from the audio modality to the video modality, the picture modality, or the presentation modality. In this way, a media content creator may convert the main modality media content to at least one sub-modality media content different from the main modality media content by inputting the modality conversion operation after creating the main modality media content by using the application. The whole modality conversion process is performed by the application based on a modality conversion algorithm thereof, without participation of a media content creator, thereby reducing a workload of the media content creator, and improving creation efficiency of the media content.

The technical solutions of the embodiments of this application are described in detail below by using some embodiments. The following several embodiments may be combined with each other, and the same or similar concepts or processes may not be described repeatedly in some embodiments.

FIG. 2 is a flowchart of a media content creation method according to an embodiment of this application.

An execution subject of this embodiment of this application is an apparatus having a media content creation function, for example, a media content creation apparatus, which is referred to as a creation apparatus for short. In some embodiments, the creation apparatus may be a terminal device, for example, the terminal device described in FIG. 1. In some embodiments, the creation apparatus may be an application installed on the terminal device. The following uses an example in which the execution subject is the terminal device for description.

As shown in FIG. 2, the method includes the following steps:

S201: The terminal device displays a main modality editing interface in response to a triggering operation.

In this embodiment of this application, as shown in FIG. 1, an application for media content creation is installed on the terminal device, which is referred to as a creation application for short below.

In some embodiments, a display of the terminal device is a touchscreen. In this way, a media content creator may interact with the terminal device by using the touchscreen, for example, interact with the creation application on the terminal device by using the touchscreen.

In some embodiments, the display of the terminal device is not the touchscreen. In this case, the terminal device further includes a mechanical key. In this way, the media content creator may interact with the terminal device by using the mechanical key, for example, interact with the creation application on the terminal device by using the mechanical key.

In some embodiments, the terminal device further supports a voice control function. In this way, the media content creator may interact with the terminal device through voice, for example, interact with the creation application on the terminal device through the voice.

In some embodiments, the terminal device further supports gesture control. In this way, the media content creator may interact with the terminal device by using a gesture, for example, interact with the creation application on the terminal device by using the gesture.

A specific manner of interaction between the media content creator and the terminal device is not limited in this embodiment of this application.

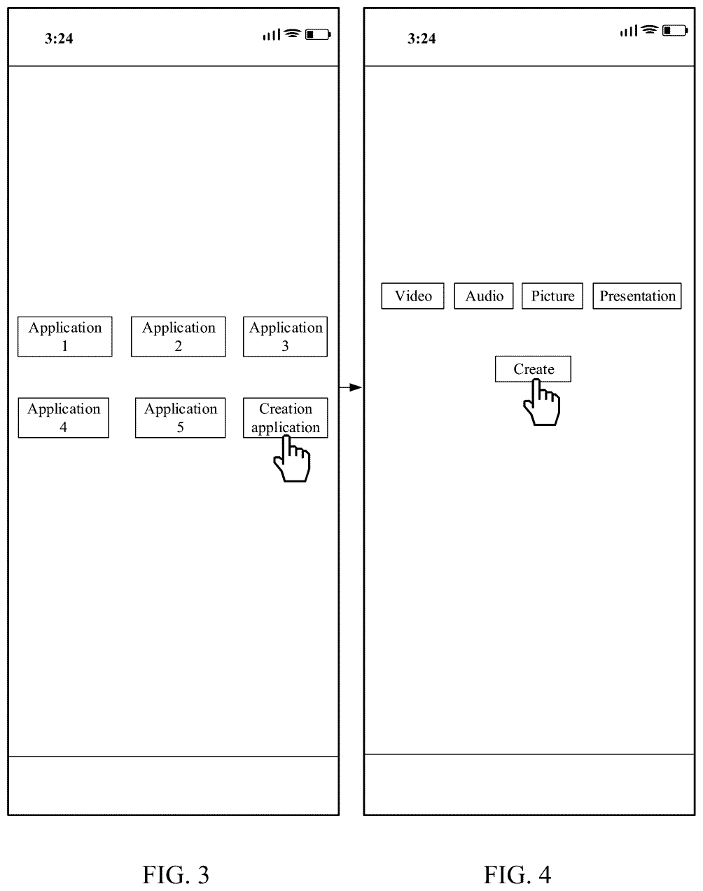

In an example, as shown in FIG. 3, after the creation application is installed on the terminal device, a creation application icon is generated on a desktop of the terminal device. When the media content creator needs to perform media creation, the media content creator may trigger the creation application icon on the desktop of the terminal device, for example, click/tap the creation application icon, and the terminal device starts the creation application.

In an example, as shown in FIG. 4, a display interface of the started creation application includes a meta-creation creating option. The meta-creation creating option is used for creating main media content. For example, if the media content creator triggers the meta-creation creating option, for example, clicks/taps the meta-creation creating option, the creation application in the terminal device displays a main modality editing interface in response to the triggering operation performed by the media content creator on the meta-creation creating option.

In some embodiments, the display interface of the started creation application includes not only the meta-creation creating option, but also a main modality selection option. The media content creator may select a main modality, for example, select a video as the main modality, or select a picture as the main modality. In the embodiment, after the media content creator (that is, a user) selects the main modality, the meta-creation creating option is triggered, and the creation application jumps to the main modality editing interface.

S202: The terminal device generates main modality media content in response to an editing operation performed on the main modality editing interface.

The creation application in the terminal device displays the main modality editing interface in response to the triggering operation performed by the media content creator on the displayed meta-creation creating option. In this way, the media content creator may create media content on the main modality editing interface, for example, edit video content, picture content, audio content, or presentation content on the main modality editing interface.

A modality in this embodiment of this application may be understood as a media form, for example, a media form such as a video, audio, a picture, or a presentation.

In some embodiments, for ease of creation of the media content creator, the main modality editing interface includes a plurality of media creation tools, for example, tools such as editing, deleting, modifying, and inserting.

In some embodiments, to further facilitate the creation of the media content creator, different creation templates may be set for media content of different modalities. For example, a video creation template, an audio creation template, a picture creation template, and a presentation creation template are set. In this way, the media content creator may select different creation templates for creation as required.

In some embodiments, different creating tools may be set for different types of creation templates. For example, the video creation template includes a plurality of tools related to video creation, the audio creation template includes a plurality of tools related to audio creation, the picture creation template includes a plurality of tools related to picture creation, and the presentation creation template includes a plurality of tools related to presentation creation.

In this embodiment of this application, a creation is referred to as a media creation task, and a media creation project is also referred to as a meta-creation project. For ease of description, the media creation project in this embodiment of this application is denoted as a first media creation project.

In this embodiment of this application, media content generated by the media content creator by performing editing on the main modality editing interface is denoted as the main modality media content. For example, if the media content creator selects a video as a main modality, the media content creator performs video editing on the main modality editing interface, and the generated main modality media content is the video content. If the media content creator selects audio as the main modality, the media content creator performs audio editing on the main modality editing interface, and the generated main modality media content is the audio content. If the media content creator selects a picture as the main modality, the media content creator performs picture editing on the main modality editing interface, and the generated main modality media content is the picture content. If the media content creator selects a presentation as the main modality, the media content creator performs presentation editing on the main modality editing interface, and the generated main modality media content is the presentation content.

In other words, in some embodiments, the main modality may be any one of the video, the audio, the picture, and the presentation.

In this embodiment of this application, the video, the audio, the picture, and the presentation are used as an example for description. However, the media modes involved in the embodiments of this application include but are not limited to the video, the audio, the picture, and the presentation, and may alternatively be another new mode, which are not limited in the embodiments of this application.

In some embodiments, after the main modality media content of the first media creation project is generated, the generated main modality media content is displayed in a creation container.

In one embodiment, the generated main modality media content is displayed in the form of a floating icon in the creation container.

In some embodiments, the floating icon includes an identifier representing a main modality form. For example, if the main modality is a video, the floating icon includes a camera identifier. If the main modality is audio, the floating icon includes a sound identifier. If the main modality is a picture, the floating icon includes a picture identifier. If the main modality is a presentation, the floating icon includes a document identifier.

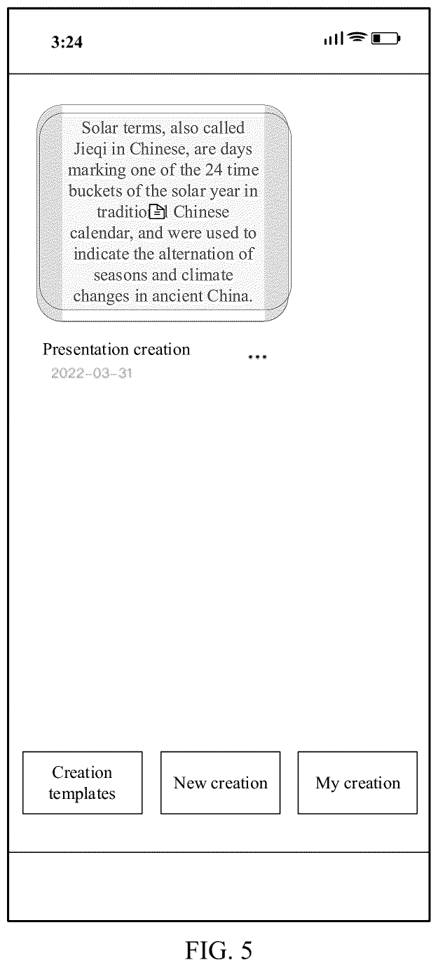

Exemplarily, as shown in FIG. 5, it is assumed that the main modality is the presentation, a floating icon is displayed in the creation container. The floating icon represents generated main modality media content, and the floating icon includes the document identifier. The media content creator may switch to the main modality editing interface by clicking/tapping the floating icon in the creation container, to implement re-editing of the main modality media content.

In some embodiments, in addition to the generated main modality media content, at least one of a cover image, a title, an update date, and an entrance to more functions corresponding to the main modality media content is also displayed in the creation container.

In this embodiment of this application, when the modalities of the main modality media content are different, the corresponding cover images are also different.

Exemplarily, if the main modality media content is the video content, the cover image may be a first image of the video content, or an image designated by the media content creator. If the main modality media content is the audio content, the cover image may be a sound wave graph corresponding to a first frame of the audio content, or a sound wave graph corresponding to a frame of the audio content designated by the media content creator. If the main modality media content is the picture content, the cover image may be a picture of the picture content, or a picture designated by the media content creator. If the main modality media content is the presentation content, the cover image may be a first page of a document where a title of the presentation content is located, or a page of the document designated by the media content creator.

In this embodiment of this application, when the modalities of the main modality media content are different, the corresponding titles are also different.

For example, when the main modality media content is the video content, the corresponding title may be the video creation. For another example, when the main modality media content is the audio content, the corresponding title may be the audio creation. For another example, when the main modality media content is the picture content, the corresponding title may be the picture creation. For another example, when the main modality media content is the presentation content, the corresponding title may be the presentation creation.

The update date may be understood as a latest time when the main modality media content is updated.

Exemplarily, it is assumed that the main modality media content is the video content, still referring to FIG. 5, a cover page corresponding to the main modality media content is displayed in the creation container. The floating icon is displayed on the cover page. The floating icon represents the generated main modality media content. The floating icon corresponding to the main modality media content is clicked/tapped to jump to an editing interface of the main modality media content. Current main modality media content may be viewed on the editing interface, and the main modality media content may be edited. In some embodiments, a topic corresponding to the main modality media content is further displayed in the creation container. For example, the topic is “video creation”, and the latest update time of the main modality media content is, for example, “Mar. 31, 2022”. In some embodiments, the entrance to more functions is further displayed in the creation container. Exemplarily, in FIG. 5, an icon “. . . ” indicates the entrance to more functions. A pull-down list of more functions may be displayed by clicking/tapping the icon. A required function may be selected in the pull-down list for execution.

In some embodiments, the foregoing S202 includes the following steps of S202-A1 and S202-A2:
S202-A1: The terminal device generates the main modality media content in response to the editing operation performed on the main modality editing interface, and determines N sub-modalities corresponding to a main modality, the N sub-modalities being different from the main modality, N being a positive integer.
S202-A2: The terminal device displays the main modality media content and to-be-converted icons of the N sub-modalities in a same creation container.

In the embodiment, the creation application in the terminal device generates the main modality media content in response to the editing operation performed by the media content creator on the main modality editing interface, and determines the N sub-modalities corresponding to the main modality, the N sub-modalities being different from the main modality. Next, the terminal device displays the main modality media content and the to-be-converted icons of the N sub-modalities in the creation container. The to-be-converted icon indicates that the N sub-modalities are not converted.

In some embodiments, S202-A2 includes that the terminal device displays the main modality media content in a first area of the creation container, and displays the to-be-converted icons of the N sub-modalities in a second area of the creation container, the first area being larger than the second area.

In some embodiments, the to-be-converted icons of the N sub-modalities displayed in the second area have the same size.

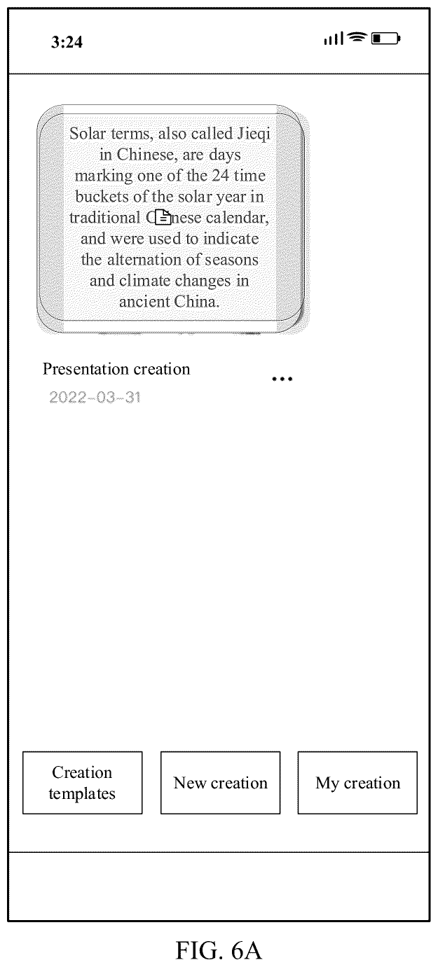

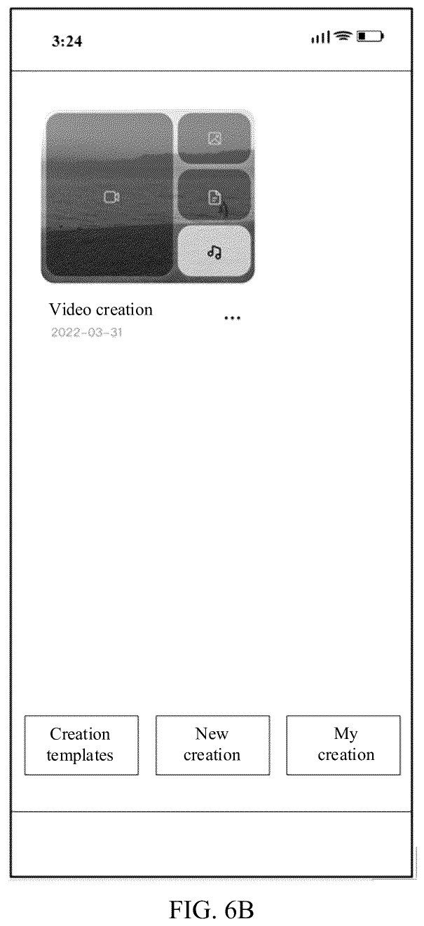

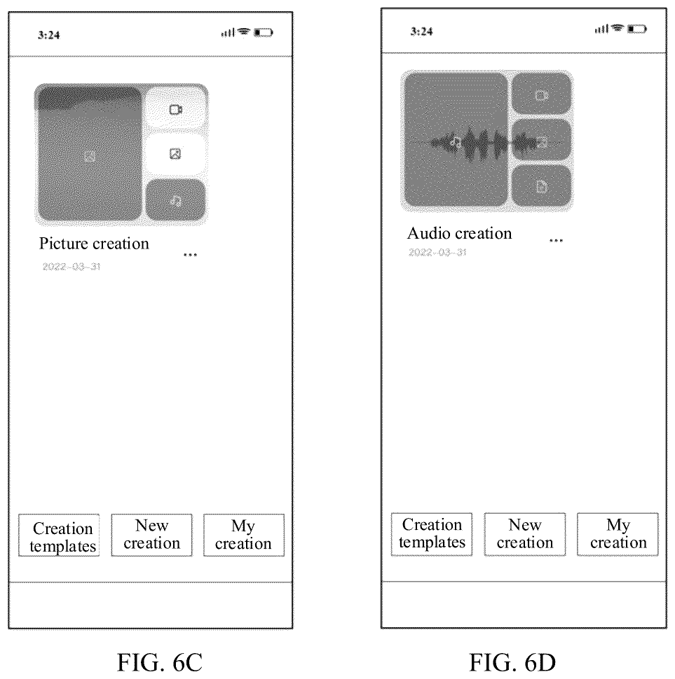

Exemplarily, as shown in FIG. 6A, assuming that the main modality is the presentation, the N sub-modalities corresponding to the main modality are the video, the picture, and the audio. In this case, in addition to an icon of the generated main modality media content, to-be-converted icons of three sub-modalities of the video, the picture, and the audio are also displayed in the creation container.

As shown in FIG. 6B, assuming that the main modality is the video, the N sub-modalities corresponding to the main modality are the picture, the presentation, and the audio. In this case, in addition to the icon of the generated main modality media content, the terminal device also displays to-be-converted icons of the three sub-modalities of the picture, the presentation, and the audio in the creation container.

As shown in FIG. 6C, assuming that the main modality is the picture, the N sub-modalities corresponding to the main modality are the video, the presentation, and the audio. In this case, in addition to an icon of the generated main modality media content, the to-be-converted icons of three sub-modalities of the video, the presentation, and the audio are also displayed in the creation container.

For example, as shown in FIG. 6D, assuming that the main modality is the audio, the N sub-modalities corresponding to the main modality are the video, the picture, and the presentation. In this case, in addition to the icon of the generated main modality media content, the terminal device also displays the to-be-converted icons of the three sub-modalities of the video, the picture, and the presentation in the creation container.

The foregoing uses N=3 as an example for description, but quantities of sub-modalities corresponding to different main modalities may be different. Further, types and quantities of sub-modalities corresponding to the main modality may be designated by the media content creator.

Based on the foregoing steps, in addition to generating the main modality media content of the first media creation project, the following step of S203 is performed.

S203: The terminal device converts the main modality media content to target sub-modality media content in response to a modality conversion operation.

In this embodiment of this application, the media content creator only needs to create and generate the main modality media content on the main modality editing interface, without generating media content of another modality. The media content of another modality may be obtained through modality conversion on the generated main modality media content, thereby reducing the workload of the media content creator and improving the creation efficiency of the media content.

A specific manner of inputting the modality conversion operation to the creation application by the media content creator is not limited in this embodiment of this application.

Manner I: The media content creator inputs a conversion instruction into the creation application. The conversion instruction is used for instructing the creation application to convert the current main modality media content to the target sub-modality media content. In this way, the creation application in the terminal device converts the main modality media content to the target sub-modality media content based on the conversion instruction. In other words, the modality conversion operation in Manner I is the conversion instruction inputted by the media content creator.

Manner II: As shown in FIG. 6A to FIG. 6D, the creation container includes the generated main modality media content and to-be-converted icons of N sub-modalities corresponding to the main modality. Conversion of sub-modality media content may be implemented by triggering the to-be-converted icon of the sub-modality. Based on this, the foregoing S203 includes the following steps of S203-A1 and S203-A2:

S203-A1: The terminal device converts the main modality media content to the target sub-modality media content in response to a triggering operation performed on a to-be-converted icon of a target sub-modality in N sub-modalities.

S203-A2: The terminal device replaces the to-be-converted icon of the target sub-modality in the creation container with the target sub-modality media content.

In Manner II, the media content creator triggers the to-be-converted icon of the target sub-modality in the to-be-converted icons of the N sub-modalities. The terminal device converts the main modality media content to the target sub-modality media content in response to the triggering operation performed on the to-be-converted icon of the target sub-modality in the N sub-modalities. Next, the terminal device replaces the to-be-converted icon of the target sub-modality in the creation container with the target sub-modality media content.

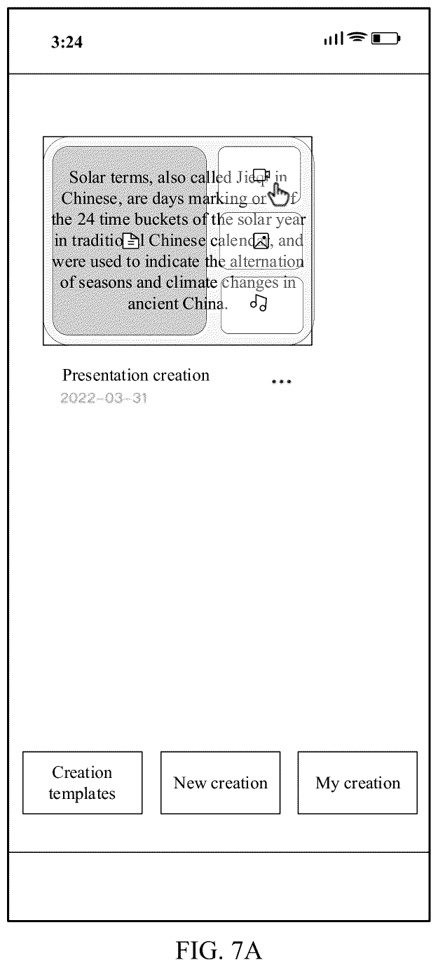

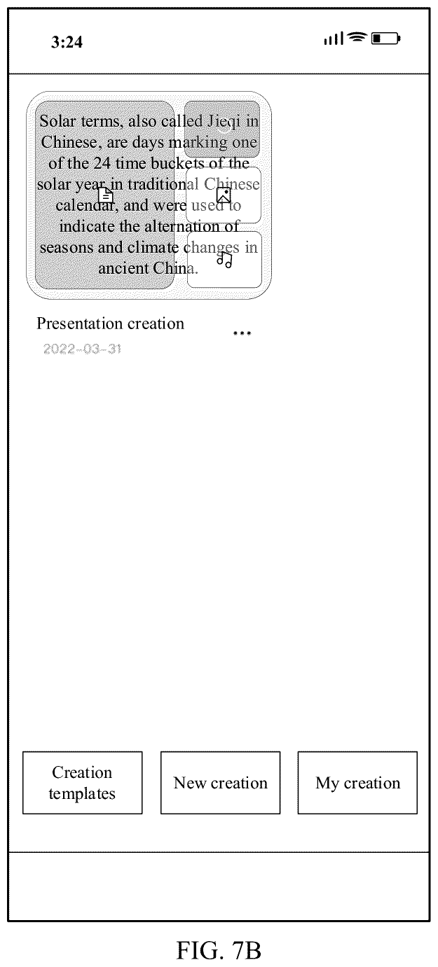

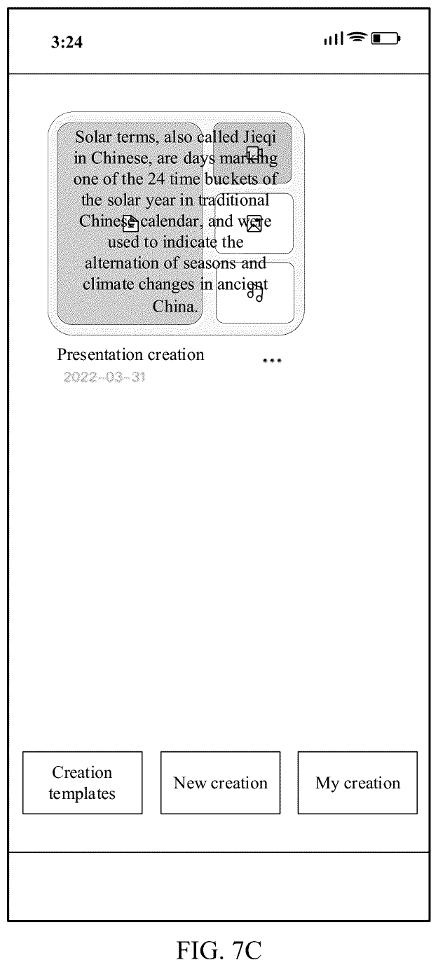

For example, the presentation creation shown in FIG. 6A above is used as an example. As shown in FIG. 7A and FIG. 6A, the creation container includes the generated main modality media content, that is, the presentation content and to-be-converted icons of three sub-modalities, which are respectively a to-be-converted video icon, a to-be-converted picture icon, and a to-be-converted audio icon. As shown in FIG. 7A, it is assumed that the media content creator clicks/taps and triggers the to-be-converted video icon of the to-be-converted icons of the three sub-modalities. The creation application in the terminal device converts the presentation content to a video sub-modality in response to the triggering operation performed on the to-be-converted video icon. FIG. 7B shows a waiting interface, which indicates that the conversion is in progress. FIG. 7C shows that the conversion is successful. In this case, the video sub-modality changes to a converted state. To be specific, the to-be-converted icon of the video sub-modality in the creation container is replaced with video sub-modality media content.

In Manner II, the modality conversion operation may be understood as the triggering operation performed by the media content creator on the to-be-converted icon of the target sub-modality.

In Manner II, the main modality media content may be converted to the sub-modality media content by triggering the to-be-converted icon of the sub-modality. The whole process is simple and time-saving, further reduces the workload of the media content creator, and improves the creation efficiency of the media content.

Manner III: An editing interface of the main modality media content includes a modality conversion option. Modality conversion may be implemented by using the modality conversion option. Based on this, the foregoing S203 includes the following steps of S203-B1 to S203-B4:
S203-B1: The terminal device displays a main modality editing interface in response to a clicking/tapping operation performed on the main modality media content, the main modality editing interface including the modality conversion option.
S203-B2: The terminal device displays to-be-converted icons of N sub-modalities in response to a triggering operation performed on the modality conversion option.
S203-B3: The terminal device converts the main modality media content to the target sub-modality media content and jumps to a sub-modality editing interface in response to the triggering operation performed on a to-be-converted icon of a target sub-modality in the N sub-modalities, the sub-modality editing interface including an editing completion option.
S203-B4: The terminal device replaces the to-be-converted icon of the target sub-modality in the creation container with the target sub-modality media content in response to a triggering operation performed on the editing completion option.

In Manner III, based on the foregoing steps, the main modality media content is generated, and the generated main modality media content is displayed in the creation container. The media content creator clicks/taps the generated main modality media content in the creation container. The creation application in the terminal device jumps to the main modality editing interface in response to a triggering operation performed on the main modality media content. The media content creator may re-edit the main modality media content on the main modality editing interface.

Further, the main modality editing interface includes the modality conversion option. The media content creator triggers the modality conversion option. The creation application in the terminal device displays the to-be-converted icons of the N sub-modalities corresponding to the main modality in response to the triggering operation performed on the modality conversion option. In this way, the media content creator may trigger the to-be-converted icons of the N sub-modalities to implement conversion of the sub-modalities. For example, the media content creator clicks/taps the to-be-converted icon of the target sub-modality in the to-be-converted icons of the N sub-modalities. The terminal device converts the main modality media content to the target sub-modality media content in response to the triggering operation performed on the to-be-converted icon of the target sub-modality in the N sub-modalities. After the conversion of the target sub-modality media content is successful, the creation application in the terminal device jumps to the sub-modality editing interface. The media content creator may edit currently generated target sub-modality media content on the sub-modality editing interface. The sub-modality editing interface includes the editing completion option. The media content creator clicks/taps the editing completion option. The creation application in the terminal device replaces the to-be-converted icon of the target sub-modality in the creation container with the target sub-modality media content in response to the triggering operation performed on the editing completion option, that is, displays the generated target sub-modality media content in the creation container.

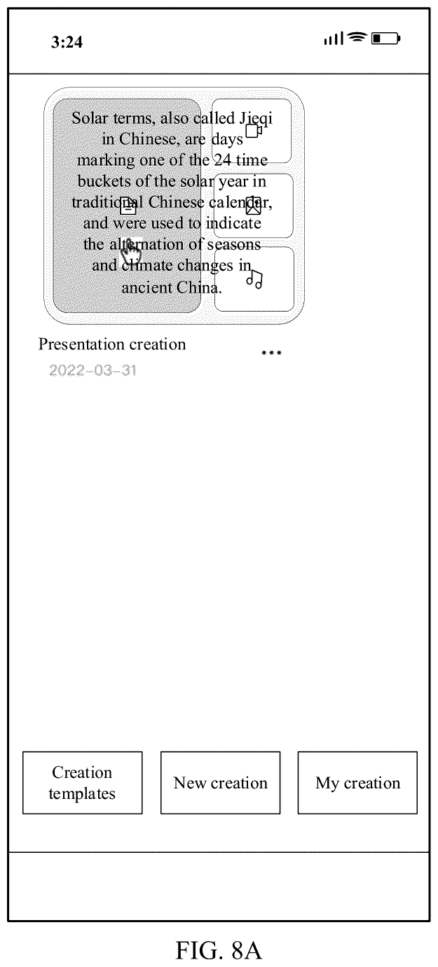

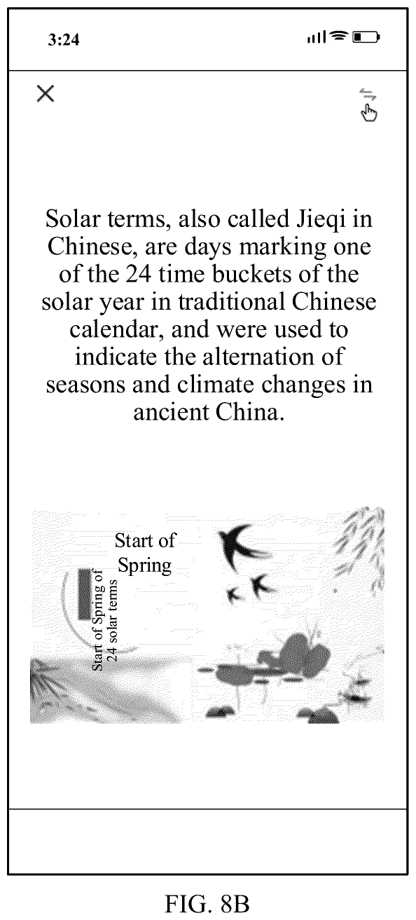

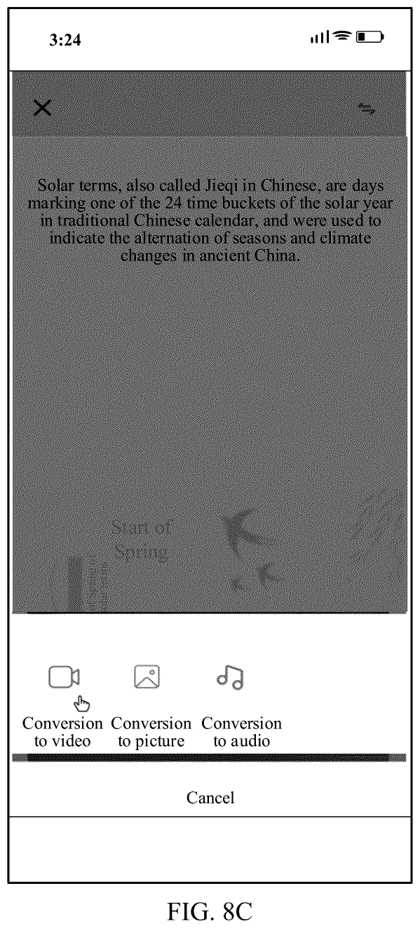

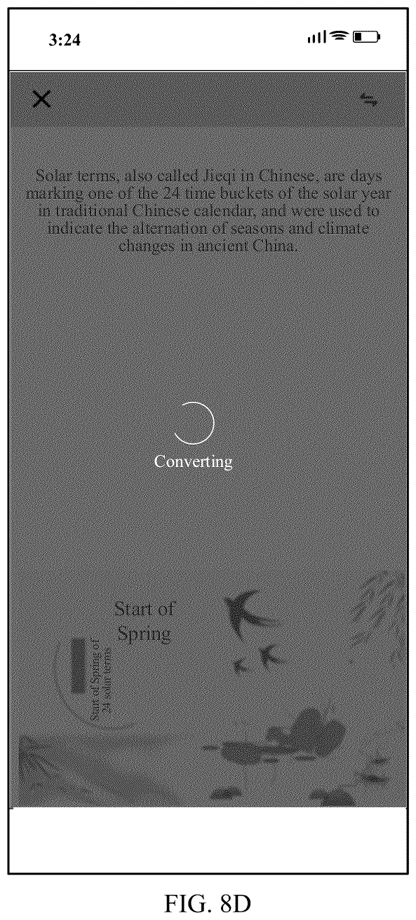

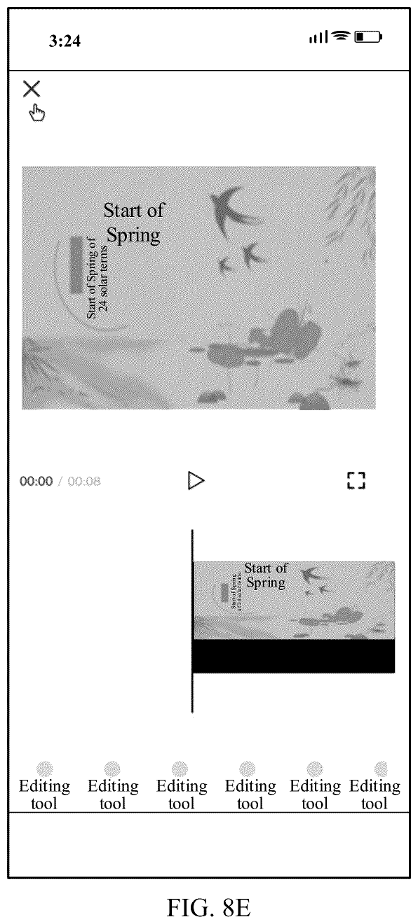

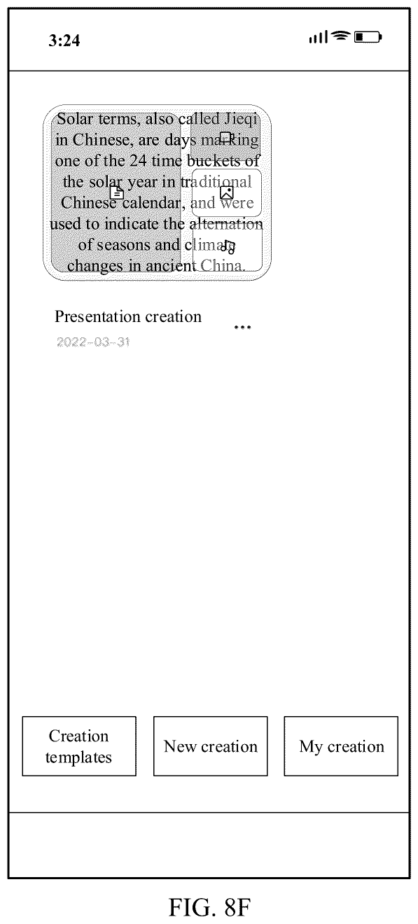

For example, the presentation creation shown in FIG. 6A above is used as an example. As shown in FIG. 8A and FIG. 6A, the creation container includes the generated main modality media content, that is, the presentation content and to-be-converted icons of three sub-modalities, which are respectively a to-be-converted video icon, a to-be-converted picture icon, and a to-be-converted audio icon. As shown in FIG. 8A, it is assumed that the media content creator clicks/taps and triggers the main modality media content, that is, the presentation content. The creation application in the terminal device jumps to a presentation editing interface in response to a clicking/tapping operation performed on presentation media content. The media content creator may re-edit the presentation media content on the presentation editing interface.

As shown in FIG. 8B, the presentation editing interface includes a modality conversion option. The media content creator triggers the modality conversion option. The creation application in the terminal device displays decoding shown in FIG. 8C in response to a triggering operation performed on the modality conversion option, that is, displays to-be-converted icons of three sub-modalities corresponding to the presentation, which are respectively a video conversion icon, a picture conversion icon, and an audio conversion icon. In this way, the media content creator may trigger the to-be-converted icons of the three sub-modalities. For example, the media content creator clicks/taps a to-be-converted icon of a video sub-modality in the to-be-converted icons of the three sub-modalities. The creation application in the terminal device converts the presentation media content to video sub-modality media content in response to the triggering operation performed on the to-be-converted icon of the video sub-modality in the three sub-modalities. Exemplarily, as shown in FIG. 8D, a conversion waiting interface indicates that the conversion is in progress.

After the video sub-modality media content is successfully converted, the creation application in the terminal device jumps to a sub-modality editing interface shown in FIG. 8E. The media content creator may edit currently generated video sub-modality media content on the sub-modality editing interface. The sub-modality editing interface includes an editing completion option. The media content creator clicks/taps the editing completion option. The creation application in the terminal device displays an interface shown in FIG. 8F in response to a triggering operation performed on the editing completion option, that is, replaces the to-be-converted icon of the video sub-modality in the creation container with the video sub-modality media content.

In some embodiments, during generation of the main modality media content, the media content creator performs creation on the main modality editing interface to generate the main modality media content. In this case, the main modality editing interface includes a modality conversion option, and the media content creator may perform modality conversion on the interface. A specific modality conversion process is similar to the foregoing descriptions of S203-B2 to S203-B4, and details are not described herein again.

A specific conversion manner of converting the main modality media content to the target sub-modality media content is not limited in this embodiment of this application.

In some embodiments, the main modality media content is converted to the target sub-modality media content based on the main modality media content. Exemplarily, an example in which the main modality is the video and the sub-modality is the picture is used. Video media content is converted to picture content based on image frames included in the video media content. For example, all images included in the video media content are converted to one or a plurality of pictures.

In some embodiment, in the foregoing S201, in addition to the main modality media content, a project file of the main modality media content is further generated in response to the editing operation performed on the main modality editing interface, the project file including a material referenced by the main modality media content and an accessible path of the material. In this case, in the foregoing S203, that the terminal device converts the main modality media content to target sub-modality media content includes: converting the main modality media content to the target sub-modality media content based on the main modality media content and the project file in response to the modality conversion operation.

In other words, in the embodiment, the main modality media content is converted to the target sub-modality media content based on the main modality media content and the project file of the main modality media content.

In one example, in the embodiment, in addition to the target sub-modality media content, a project file of the target sub-modality media content is further generated.

A specific type of the media modality is not limited in this embodiment of this application.

In some embodiments, this embodiment of this application includes four types of media modalities: video, audio, picture, and presentation. In this case, during modality conversion, 4 categories and 12 types of conversion logics are generated.

The conversion logics involved in this embodiment of this application are described below.

Example 1: A project of conversion to a video, which is to convert a picture, a presentation, or audio to a video. Specifically, visual elements are extracted from inputted modality (that is, a main modality) media content and a project file for project file construction, and a video project is constructed by using time-stamped data fragments in combination with referenced material files. A video intelligence algorithm is mainly responsible for extracting a picture layer material, a text layer material, and an audio layer material from an input source, and splicing and generating video media content, and a project file of the video media content.

For example, assuming that the main modality is the picture and the target sub-modality is the video, the terminal device calls a preset picture-to-video algorithm in response to triggering of a video sub-modality by a media content creator, and converts picture media content to video content by using the picture-to-video algorithm. A specific type of the picture-to-video algorithm is not limited in this embodiment of this application. In one embodiment, the terminal device extracts the picture layer material in the picture by using the picture-to-video algorithm, for example, objects such as a person, an animal, a building, or a landscape in the picture, and makes a video based on the picture layer material, for example, uses at least one visual element as a video frame, and then converts the picture to a video. In another embodiment, the terminal device cuts the picture based on a preset requirement for a video frame size in a preset video template by using the picture-to-video algorithm, adds a transition effect between the video frames based on the video template, adds a filter to the video frame, adds opening credits or closing credits and soundtrack in some embodiments, and then converts the picture to the video. In addition, the picture and a project file of the picture are used as the project file of the video media content.

For another example, assuming that the main modality is the presentation and the target sub-modality is the video, the terminal device calls a preset presentation-to-video algorithm in response to triggering of a video sub-modality by the media content creator, and converts the presentation media content to video media content by using the presentation-to-video algorithm. A specific type of the presentation-to-video algorithm is not limited in this embodiment of this application. In one embodiment, the terminal device extracts the text layer material in the presentation by using the presentation-to-video algorithm, and generates image-text video content based on the text layer material. In some embodiments, the terminal device adds a special effect, a filter sticker, and the like to the image-text video content by using the presentation-to-video algorithm. The beautification effects such as the special effect or the filter sticker may be set in a template by default, or may be autonomously selected by the media content creator. In addition, the presentation and a project file of the presentation are used as the project file of the video media content.

For another example, assuming that the main modality is the audio and the target sub-modality is the video, the terminal device calls a preset audio-to-video algorithm in response to triggering of a video sub-modality by the media content creator, and converts audio media content to video content by using the audio-to-video algorithm. A specific type of the audio-to-video algorithm is not limited in this embodiment of this application. In one embodiment, the terminal device extracts an audio layer material in audio content by using the audio-to-video algorithm, and generates voice and video content based on the audio layer material. In some embodiments, the terminal device adds a special effect, a filter sticker, subtitles, and the like to the voice and video content by using the audio-to-video algorithm. The beautification effects such as the special effect, the filter sticker, or the subtitles may be set in a template by default, or may be autonomously selected by the media content creator. In addition, the audio and a project file of the audio are used as the project file of the video media content.

Example 2: A project of conversion to audio, which is to extract an audio material from media content of an input modality and a project file or generate audio media content and a project file of the audio media content based on characters.

For example, assuming that the main modality is a picture and the target sub-modality is audio, the terminal device calls a preset picture-to-audio algorithm in response to triggering of an audio sub-modality by the media content creator, and converts picture media content to audio content by using the picture-to-audio algorithm. A specific type of the picture-to-audio algorithm is not limited in this embodiment of this application. In one embodiment, the terminal device extracts text content in the picture by using the picture-to-audio algorithm, for example, extracts characters in the picture, makes audio based on the text content, for example, converts the text content in the picture to a voice form, and then forms audio media content. In addition, the picture and a project file of the picture are used as the project file of the audio media content.

For another example, assuming that the main modality is a presentation and the target sub-modality is the audio, the terminal device calls a preset presentation-to-audio algorithm in response to triggering of an audio sub-modality by the media content creator, and converts the presentation media content to audio media content by using the presentation-to-audio algorithm. A specific type of the presentation-to-audio algorithm is not limited in this embodiment of this application. In one embodiment, the terminal device extracts the text layer material in the presentation by using the presentation-to-audio algorithm, and generates audio content based on the text layer material. For example, text content in the presentation is converted to a voice form, and then audio media content is formed. In addition, the presentation and a project file of the presentation are used as the project file of the audio media content.

For another example, assuming that the main modality is a video and the target sub-modality is the audio, the terminal device calls a preset video-to-audio algorithm in response to triggering of an audio sub-modality by the media content creator, and converts video media content to audio content by using the video-to-audio algorithm. A specific type of the video-to-audio algorithm is not limited in this embodiment of this application. In one embodiment, the terminal device extracts an audio layer material in video content by using the video-to-audio algorithm, and generates audio content based on the audio layer material. For example, subtitles or presentations, voice information, and the like are extracted from the video, and the information is converted to an audio form, to obtain audio media content. In addition, the video and a project file of the video are used as the project file of the audio media content.

Example 3: A project of conversion to a picture, which is to extract a picture character element is extracted from inputted modality media content and a project file and map the picture character element to a picture intelligence template, to generate picture media content and a project file of the picture media content.

For example, assuming that the main modality is a video and the target sub-modality is a picture, the terminal device calls a preset video-to-picture algorithm in response to triggering of a picture sub-modality by the media content creator, and converts video media content to picture content by using the video-to-picture algorithm. A specific type of the video-to-picture algorithm is not limited in this embodiment of this application. In one embodiment, the terminal device maps video frames included in the video media content to a picture intelligence template corresponding to the video-to-picture algorithm by using the video-to-picture algorithm, and merges the video frames into one or a plurality of pictures. In addition, the video and a project file of the video are used as the project file of the picture media content.

For another example, assuming that the main modality is a presentation and the target sub-modality is a picture, the terminal device calls a preset presentation-to-picture algorithm in response to triggering of a picture sub-modality by the media content creator, and converts presentation media content to picture media content by using the presentation-to-picture algorithm. A specific type of the presentation-to-picture algorithm is not limited in this embodiment of this application. In one embodiment, the terminal device extracts text layer materials from the presentation by using the presentation-to-picture algorithm, maps the text layer materials to a picture intelligence template corresponding to the presentation-to-picture algorithm, and merges the text layer materials into one or a plurality of pictures. In addition, the presentation and a project file of the presentation are used as the project file of the picture media content.

For another example, assuming that the main modality is audio and the target sub-modality is the picture, the terminal device calls a preset audio-to-picture algorithm in response to triggering of a picture sub-modality by the media content creator, and converts audio media content to picture media content by using the audio-to-picture algorithm. A specific type of the audio-to-picture algorithm is not limited in this embodiment of this application. In one embodiment, the terminal device extracts character elements from the audio by using the audio-to-picture algorithm, maps the character elements to a picture intelligence template corresponding to the audio-to-picture algorithm, and merges the character elements into one or a plurality of pictures. In addition, the audio and a project file of the audio are used as the project file of the picture media content.

Example 4: A project of conversion to a presentation, which is to extract character and picture content from media content of an input modality and a project file, and construct unstyled presentation media content and a project file of the presentation media content based on a logical sequence.

For example, assuming that the main modality is a video and the target sub-modality is a presentation, the terminal device calls a preset video-to-presentation algorithm in response to triggering of a presentation sub-modality by the media content creator, and converts video media content to presentation content by using the video-to-presentation algorithm. A specific type of the video-to-presentation algorithm is not limited in this embodiment of this application. In one embodiment, the terminal device extracts text information from the video by using the video-to-presentation algorithm, for example, extracts text information from a text picture in video frames and text information from a video subtitle, maps the text information to a presentation intelligence template, and generates presentation media content. In addition, the video and a project file of the video are used as the project file of the presentation media content.

For example, assuming that the main modality is a picture and the target sub-modality is the presentation, the terminal device calls a preset picture-to-presentation algorithm in response to triggering of a presentation sub-modality by the media content creator, and converts picture media content to presentation content by using the picture-to-presentation algorithm. A specific type of the picture-to-presentation algorithm is not limited in this embodiment of this application. In one embodiment, the terminal device extracts text information from the picture by using the picture-to-presentation algorithm, for example, extracts character information from the picture, maps the text information to a presentation intelligence template, and generates presentation media content. In addition, the picture and a project file of the picture are used as the project file of the presentation media content.

For example, assuming that the main modality is audio and the target sub-modality is a presentation, the terminal device calls a preset audio-to-presentation algorithm in response to triggering of a presentation sub-modality by the media content creator, and converts audio media content to presentation content by using the audio-to-presentation algorithm. A specific type of the audio-to-presentation algorithm is not limited in this embodiment of this application. In one embodiment, the terminal device converts voice information in the audio to text information by using the audio-to-presentation algorithm, maps the text information to a presentation intelligence template, and generates presentation media content. In addition, the audio and a project file of the audio are used as the project file of the presentation media content.

It may be learned from the foregoing that, in this embodiment of this application, during conversion of main modality media content to target sub-modality media content, content corresponding to the target sub-modality is extracted from the main modality media content, and then the target sub-modality media content is generated based on the extracted content corresponding to the target sub-modality. For example, when the main modality is the video and the target sub-modality is the picture, at least one picture is extracted from the video, and picture media content is generated based on the extracted at least one picture. For another example, when the main modality is the video and the target sub-modality is the presentation, text information is extracted from the video, and presentation media content is generated based on the extracted text information.

In this embodiment of this application, a creation application automatically calls a conversion logic based on an input modality and a target output modality that currently initiate intelligent conversion. When a plurality of modes exist in a category of logics, the media content creator is supported in selecting one of the logics actively or executing one of the logics by default. For example, in a project of conversion to a picture, two types of logics exist: conversion to a long picture or conversion to a short picture. The media content creator may select one logic from the two types of logics for picture conversion, or may perform picture conversion with one logic by default.

Based on the foregoing steps, after the terminal device converts the main modality media content to the target sub-modality media content in response to the modality conversion operation, the following step S204 is performed.

S204: The terminal device displays the generated main modality media content and the target sub-modality media content.

In some embodiments, the terminal device displays the generated main modality media content and the target sub-modality media content in the same creation container.

In some embodiments, the main modality media content and the target sub-modality media content are both displayed in the creation container in the form of a floating icon.

In this embodiment of this application, the generated main modality media content and the target sub-modality media content both support re-editing.

Based on this, in some embodiments, the method in the embodiments of this application further includes the following step 11 and step 12:
Step 11: A terminal device displays a sub-modality editing interface in response to a triggering operation performed on the target sub-modality media content, the sub-modality editing interface including a plurality of first editing tools.
Step 12: The terminal device displays, in response to editing of the target sub-modality media content by using the plurality of first editing tools, the edited target sub-modality media content.

Specifically, the media content creator clicks/taps the target sub-modality media content in the creation container. The creation application in the terminal device displays the sub-modality editing interface in response to the triggering operation performed on the target sub-modality media content. The sub-modality editing interface includes the plurality of first editing tools. The media content creator may edit the target sub-modality media content by using the plurality of first editing tools. The creation application in the terminal device displays, in response to the editing of the target sub-modality media content by the media content creator by using the plurality of first editing tools, the edited target sub-modality media content.

In some embodiments, the plurality of first editing tools on the foregoing sub-modality editing interface include a creating tool. The creating tool is used for creating the current target sub-modality media content as main modality media content of another media creation project. Based on this, if the media content creator triggers the creating tool on the sub-modality editing interface, the creation application in the terminal device creates the target sub-modality media content as main modality media content of a second media creation project in response to a triggering operation performed on the creating tool.

In other words, sub-modality media content in a first media creation project may be created as the main modality media content of the second media creation project by triggering the creating tool on the sub-modality editing interface.

In some embodiments, the method in the embodiments of this application further includes the following step 21 and step 22:
Step 21: The terminal device displays a main modality editing interface of the main modality media content in response to a triggering operation performed on the main modality media content, the main modality editing interface including a plurality of second editing tools.
Step 22: The terminal device displays, in response to editing of the main modality media content by using the plurality of second editing tools, the edited main modality media content.

Specifically, the media content creator clicks/taps the main modality media content in the creation container. The creation application in the terminal device displays the main modality editing interface in response to the triggering operation performed on the main modality media content. The main modality editing interface includes the plurality of second editing tools. The media content creator may edit the main modality media content by using the plurality of second editing tools. The creation application in the terminal device displays, in response to the editing of the main modality media content by the media content creator by using the plurality of second editing tools, the edited main modality media content.

In some embodiments, the plurality of second editing tools on the foregoing main modality editing interface include a copying tool. The copying tool is used for creating the current main modality media content as main modality media content of another media creation project. Based on this, if the media content creator triggers the copying tool on the main modality editing interface, the creation application in the terminal device creates the main modality media content of the first media creation project as main modality media content of a third media creation project in response to a triggering operation performed on the copying tool.

In other words, the main modality media content of the first media creation project may be copied as the main modality media content of the third media creation project by triggering the copying tool on the main modality editing interface.

The third media creation project may be the same as the foregoing second media creation project, or may be different from the foregoing second media creation project, which is not limited in this embodiment of this application.

In some embodiments, based on the foregoing steps, after the main modality media content and the target sub-modality media content of the first media creation project are generated, the main modality media content and the target sub-modality media content of the first media creation project may be stored in a cloud storage file.

In some embodiments, the creation application in this embodiment of this application further provides an operation option. The operation option includes operations such as renaming, deleting, sharing, removing, and the like. The media content creator may perform an operation on at least one of the main modality media content and the target sub-modality media content by using the operations included in the operation option. For example, the media content creator triggers a target operation in the operation option. The creation application in the terminal device performs the target operation on at least one of the main modality media content and the target sub-modality media content in response to triggering of the target operation in the operation option. The target operation includes a renaming operation, a deleting operation, a sharing operation, or a moving operation.

For example, the media content creator deletes at least one of the main modality media content and the target sub-modality media content by triggering the deleting operation. Alternatively, the media content creator renames at least one of the main modality media content and the target sub-modality media content by triggering the renaming operation. Alternatively, the media content creator shares at least one of the main modality media content and the target sub-modality media content by triggering the sharing operation. Alternatively, the media content creator moves a position of at least one of the main modality media content and the target sub-modality media content in the creation container by triggering the moving operation.

In some embodiments, to maintain consistency between a terminal side and a cloud side, if the target operation is performed on the at least one of the main modality media content and the target sub-modality media content on the terminal side, the target operation performed on the at least one of the main modality media content and the target sub-modality media content is synchronized to the cloud storage file, so that the target operation is performed on at least one piece of media content in the cloud storage file. For example, after obtaining the target operation, the cloud side performs the target operation on at least one of the main modality media content and the target sub-modality media content in the same manner as the terminal side, to maintain consistency of the content stored on two sides.

In some embodiments, the foregoing operation option is located in an option of more functions of the creation container.

In some embodiments, the foregoing target operation is a copying operation. The copying operation is substantially the same as a function of the copying tool on the foregoing main modality editing interface. In an example, if the media content creator triggers the copying operation in the operation option, the creation application copies at least one of the main modality media content and the target sub-modality media content as main modality media content of a new media creation project in response to triggering of the copying operation. For example, the main modality media content of the first media creation project is copied as the main modality media content of the third media creation project, and the target sub-modality media content of the first media creation project is copied as the main modality media content of the second media creation project.

In some embodiments, the creation application in this embodiment of this application further includes an export option. In this case, the method in the embodiments of this application further includes: exporting, by the creation application, at least one of the main modality media content and the target sub-modality media content of the first media creation project in response to a triggering operation performed by the media content creator on the export option.

In the embodiment, the creation application supports content exporting of a meta-creation project. The content exporting supports exporting of the content of the meta-creation project as a specific single media file and synchronous format conversion based on a meta-creation project file and an API for exporting and posting videos, audio, pictures, and presentations.

From a target dimension of exporting, in this embodiment of this application, the content may be exported as a locally stored media file, or an interface may be called to perform asynchronous rendering and exporting on a server side to obtain an object storage file.

From a logical dimension of exporting, in this embodiment of this application, four types of commonly used media encapsulation formats are supported. For example, a video file can be exported as encapsulated files in a plurality of video encoding formats such as mp4. A presentation file can be exported as a TXT plain text or a document in the format of WORD and PDF, or exported as an HTML file.

In some embodiments, the foregoing export option may be located in the option of more functions of the creation container.

In some embodiments, the creation application in this embodiment of this application further includes a posting option. In this case, the method in the embodiments of this application further includes: posting, by the creation application, at least one of the main modality media content and the target sub-modality media content of the first media creation project to a third-party platform in response to a triggering operation performed by the media content creator on the posting option.

To be specific, in this embodiment of this application, the created content of the first media creation project may be posted on an Internet platform. For example, the creation application posts at least one of the main modality media content and the target sub-modality media content of the first media creation project to the third-party platform by using a sharing interface of a front-end SDK or a posting interface of a back-end API of the creation application.

In some embodiments, the foregoing posting option may be located in the option of more functions of the creation container.

This embodiment of this application provides a media content creation method, including: displaying a main modality editing interface in response to a triggering operation; generating main modality media content in response to an editing operation performed on the main modality editing interface; converting the main modality media content to target sub-modality media content in response to a modality conversion operation; and displaying the generated main modality media content and the target sub-modality media content. In other words, in the embodiments of this application, conversion among a plurality of pieces of modality media content is supported. A media content creator may convert the main modality media content to at least one piece of sub-modality media content different from the main modality media content by inputting the modality conversion operation after creating the main modality media content by using an application. The whole modality conversion process is performed by the application based on a modality conversion algorithm thereof, without participation of the media content creator, thereby reducing a workload of the media content creator, and improving creation efficiency of the media content.

The creation process of the media content involved in the embodiments of this application is described above, and the whole process of creating the media content in the embodiments of this application is described below.

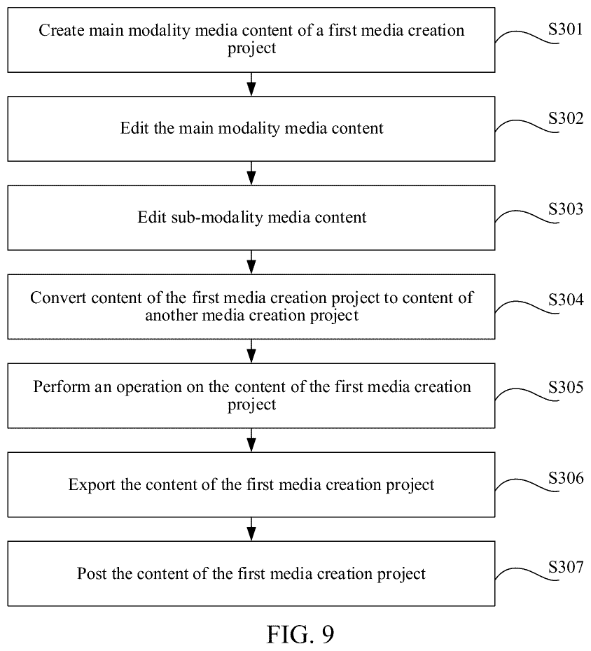

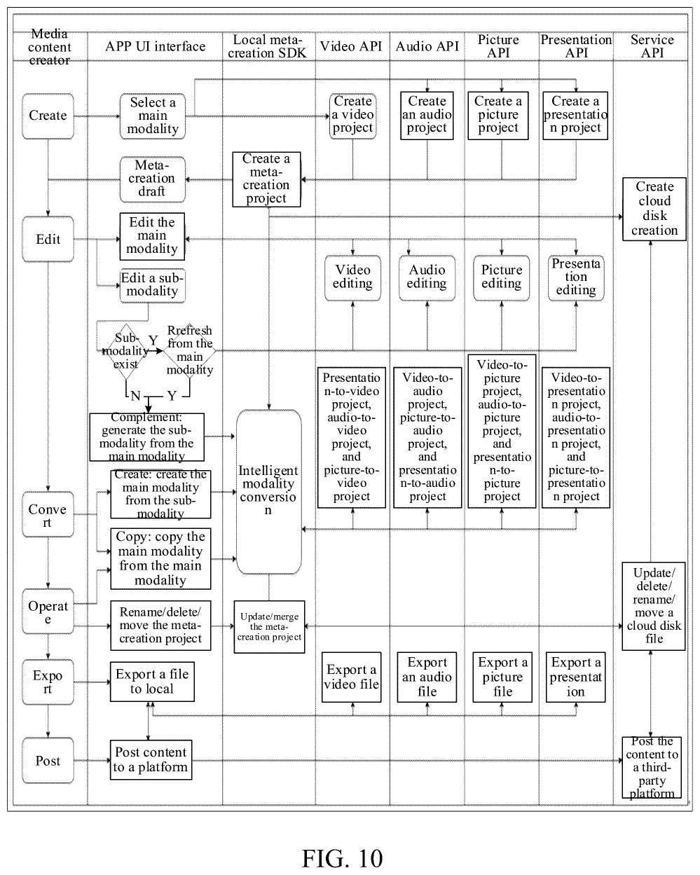

FIG. 9 is a schematic flowchart of a media content creation method according to an embodiment of this application. FIG. 10 is a schematic diagram of interaction between a creation application in a terminal device and a media content creator and within the creation application according to an embodiment of this application.

As shown in FIG. 9 and FIG. 10, the method in this embodiment of this application includes the following steps:
S301: Create main modality media content of a first media creation project.

Specifically, the creation application in the terminal device displays a main modality editing interface in response to a triggering operation performed by the media content creator on a displayed meta-creation creating option. The creation application in the terminal device generates the main modality media content in response to an editing operation performed by the media content creator on the main modality editing interface.

As shown in FIG. 10, the creation application in this embodiment of this application includes a user interface (UI), a local meta-creation SDK, and a plurality of APIs. The local meta-creation SDK is mainly used for creating a meta-creation project, implement intelligent modality conversion, update/merge the meta-creation project, and the like.

In this embodiment of this application, an example in which a media modality is a video, audio, a picture, and a presentation is used. The creation application includes a video API, an audio API, a picture API, and a presentation API. In some embodiments, the creation application further includes a service API.

During generation of the main modality media content of the first media creation project, the media content creator triggers a meta-creation creating option on the UI and selects a main modality. In response to the operation performed by the media content creator, the main modality editing interface is displayed on the UI. The media content creator creates the main modality media content on the main modality editing interface. The local meta-creation SDK creates the main modality media content and a project file corresponding to the main modality media content by calling a project creation algorithm related to the main modality. In this embodiment of this application, the main modality media content is referred to as a meta-creation draft.

For example, as shown in FIG. 10, if the main modality is a video, a local SDK creates a video project by using the video API. If the main modality is audio, the local SDK creates an audio project by using the audio API. If the main modality is a picture, the local SDK creates a picture project by using the picture API. If the main modality is the presentation, the local SDK creates a presentation project by using the presentation API.

The foregoing project creation includes creation of the main modality media content and a meta-creation project file.

In some embodiments, the main modality media content is included in the meta-creation project file. In other words, the meta-creation project file includes the created main modality media content, a material related to the main modality media content, a storage path of the material, and the like.

For a specific implementation process of the foregoing S301, reference may be made to the foregoing description of S201 and S202.

In some embodiments, as shown in FIG. 10, after generating the main modality media content of the first media creation project, the creation application may call the service API to create cloud disk meta-creation, that is, store the main modality media content of the first media creation project in a cloud storage file, for example, in a cloud disk.

S302: Edit the main modality media content.

Specifically, the creation application in the terminal device displays a main modality editing interface of the main modality media content in response to a triggering operation performed on the main modality media content, the main modality editing interface including a plurality of second editing tools. The creation application in the terminal device displays, in response to editing of the main modality media content by using the plurality of second editing tools, the edited main modality media content.

To be specific, when choosing to edit the main modality media content from the UI, the media content creator directly calls a corresponding modality editing tool to enter an editing state. For example, as shown in FIG. 10, when the main modality is a video, an editing tool of a video modality is called by calling the video API to enter a video modality editing interface.

S303: Edit sub-modality media content.

The media content creator first needs to perform service logic determination when choosing to edit a sub-modality from the UI. When choosing to edit the sub-modality for the first time, the media content creator needs to generate the sub-modality based on the main modality and then can enter a corresponding sub-modality editing state.

Specifically, it is determined whether the selected sub-modality media content exists. If the selected sub-modality media content does not exist, the following S304 is performed. If the selected sub-modality media content exists, it is determined whether current main modality media content is updated. If the current main modality media content is updated, S303-A is performed. If the current main modality media content is not updated, S303-B and S303-C are performed.

S303-A: The creation application in the terminal device generates the sub-modality media content from the main modality media content.

For example, the creation application in the terminal device converts main modality media content to target sub-modality media content in response to a triggering operation performed on a to-be-converted icon of a target sub-modality in N sub-modalities, and replaces the to-be-converted icon of the target sub-modality in the creation container with the target sub-modality media content. Next, the following S303-B and S303-C are performed.

S303-B: The creation application in the terminal device displays a sub-modality editing interface in response to the triggering operation performed on the target sub-modality media content, the sub-modality editing interface including a plurality of first editing tools.

S303-C: The creation application in the terminal device displays, in response to editing of the target sub-modality media content by using the plurality of first editing tools, the edited target sub-modality media content.

For example, if the main modality is the video, as shown in FIG. 10, an intelligent modality conversion module in the local SDK implements a video-to-audio project by calling the audio API, implements a video-to-picture project by calling the picture API, and implements a video-to-presentation project by calling the presentation API.

S304: Convert content of the first media creation project to content of another media creation project.

In an example, the creation application in the terminal device displays the sub-modality editing interface in response to the triggering operation performed on the target sub-modality media content, the sub-modality editing interface including a plurality of first editing tools, the plurality of first editing tools including a creating tool. The creation application in the terminal device creates the target sub-modality media content as main modality media content of a second media creation project in response to a triggering operation performed on the creating tool.

To be specific, the sub-modality media content of the first media creation project is created as main modality media content of another media creation project.

In another example, the creation application in the terminal device displays a main modality editing interface of the main modality media content in response to the triggering operation performed on the main modality media content, the main modality editing interface including a plurality of second editing tools, the plurality of second editing tools including a copying tool. The creation application in the terminal device copies the main modality media content as main modality media content of a third media creation project in response to a triggering operation performed on the copying tool.

To be specific, the main modality media content of the first media creation project is created as main modality media content of another media creation project.

S305: Perform an operation on the content of the first media creation project.

For example, the creation application in the terminal device performs a target operation on at least one of the main modality media content and the target sub-modality media content in response to triggering of the target operation in the operation option. The target operation includes a renaming operation, a deleting operation, a sharing operation, or a moving operation.

In some embodiments, the main modality media content and the target sub-modality media content of the first media creation project are stored in the cloud storage file. Based on this, the target operation is synchronized to the cloud storage file, so that the target operation is performed on at least one piece of media content in the cloud storage file, to maintain consistency of media content stored on the terminal side and the cloud side.

In some embodiments, the operation option includes a copying operation. The creation application in the terminal device copies at least one of the main modality media content and the target sub-modality media content as main modality media content of a new media creation project in response to triggering of the copying operation.

S306: Export the content of the first media creation project.

For example, the creation application in the terminal device exports at least one of the main modality media content and the target sub-modality media content of the first media creation project in response to a triggering operation performed on an export option.

In some embodiments, during exporting of the media content, a project file corresponding to the media content is also exported.

Exemplarily, as shown in FIG. 10, assuming that a video file is exported, the creation application in the terminal device responds to the triggering operation performed on the export option, and a user interface of the creation application exports the video file by calling the video API. The video file includes video media content and a corresponding project file.

S307: Post the content of the first media creation project.

For example, the creation application in the terminal device posts at least one of the main modality media content and the target sub-modality media content of the first media creation project to a third-party platform in response to a triggering operation performed on a posting option.

In this embodiment of this application, through the meta-creation process, a creator may create works for different social media at one time based on a specific theme, and quickly complete the whole process of generation, editing, and posting by using an intelligent template. In addition, in this embodiment of this application, an intelligent conversion tool based on meta-creation may effectively induce a plurality of creation tools and interfaces according to types of input and output sources and operation objectives, thereby implementing maximum decoupling between the tool and the service process. Further, in this embodiment of this application, associated design of the main modality and the sub-modality may assist the creator in decomposing creation elements respectively from dimensions such as copywriting, audio, visual, audio-visual, and a corresponding project file may be relatively separated from a referenced material, thereby more effectively generating a creation template that does not rely on a specific material.

It is to be understood that FIG. 2 to FIG. 10 are merely examples of this application, and are not to be construed as limitations on this application.

Preferred implementations of this application are described in detail above with reference to the accompany drawings. However, this application is not limited to specific details in the foregoing implementations. A plurality of simple variations may be made to the technical solutions of this application within the scope of the technical concept of this application, and these simple variations fall within the protection scope of this application. For example, the specific technical features described in the foregoing specific implementations may be combined in any proper manner in the case of no contradiction. To avoid unnecessary repetition, various example combinations are not described separately in this application. For another example, various different implementations of this application may also be combined in different manners to form other embodiments without departing from the idea of this application, and the combinations are still regarded as the content disclosed in this application.

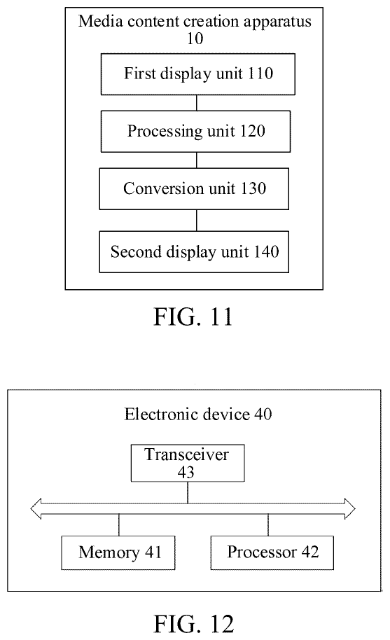

The method embodiment of this application is described in detail above with reference to FIG. 11 to FIG. 12. An apparatus embodiment of this application is described in detail below.

FIG. 11 is a schematic structural diagram of a media content creation apparatus according to an embodiment of this application.

As shown in FIG. 11, a media content creation apparatus 10 is applied to a terminal device, and includes:
a first display unit 110, configured to display a main modality editing interface in response to a triggering operation;
a processing unit 120, configured to generate main modality media content in response to an editing operation performed on the main modality editing interface;
a conversion unit 130, configured to convert the main modality media content to target sub-modality media content in response to a modality conversion operation; and
a second display unit 140, configured to display the generated main modality media content and the target sub-modality media content.

In some embodiments, the processing unit 120 is specifically configured to generate the main modality media content in response to the editing operation performed on the main modality editing interface, and determine N sub-modalities corresponding to a main modality, the N sub-modalities being different from the main modality, N being a positive integer. The second display unit 140 is further configured to display the main modality media content and to-be-converted icons of the N sub-modalities in a same creation container.

In some embodiments, the modality conversion operation is a triggering operation performed on a to-be-converted icon of a target sub-modality. The conversion unit 130 is specifically configured to: convert the main modality media content to the target sub-modality media content in response to the triggering operation performed on the to-be-converted icon of the target sub-modality in the N sub-modalities; and replace the to-be-converted icon of the target sub-modality in the creation container with the target sub-modality media content.

In some embodiments, the modality conversion operation is a triggering operation performed on a modality conversion option. The conversion unit 130 is specifically configured to: display the main modality editing interface in response to a clicking/tapping operation performed on the main modality media content, the main modality editing interface including the modality conversion option; display the to-be-converted icons of the N sub-modalities in response to the triggering operation performed on the modality conversion option; convert the main modality media content to the target sub-modality media content and jump to a sub-modality editing interface in response to the triggering operation performed on a to-be-converted icon of a target sub-modality in the N sub-modalities, the sub-modality editing interface including an editing completion option; and replace the to-be-converted icon of the target sub-modality in the creation container with the target sub-modality media content in response to a triggering operation performed on the editing completion option.

In some embodiments, the processing unit 120 is specifically configured to generate the main modality media content and a project file of the main modality media content in response to the editing operation performed on the main modality editing interface, the project file including a material referenced by the main modality media content and an accessible path of the material. The conversion unit 130 is specifically configured to convert the main modality media content to the target sub-modality media content based on the main modality media content and the project file in response to the modality conversion operation.

In some embodiments, the second display unit 140 is specifically configured to display the main modality media content in a first area of the creation container, and display the to-be-converted icons of the N sub-modalities in a second area of the creation container, the first area being larger than the second area.

In some embodiments, the processing unit 120 is further configured to: display a sub-modality editing interface in response to a triggering operation performed on the target sub-modality media content, the sub-modality editing interface including a plurality of first editing tools; and display, in response to editing of the target sub-modality media content by using the plurality of first editing tools, the edited target sub-modality media content.

In some embodiments, the plurality of first editing tools include a creating tool. The processing unit 120 is further configured to create the target sub-modality media content as main modality media content of a second media creation project in response to a triggering operation performed on the creating tool.

In some embodiments, the processing unit 120 is further configured to: display a main modality editing interface of the main modality media content in response to a triggering operation performed on the main modality media content, the main modality editing interface including a plurality of second editing tools; and in response to editing of the main modality media content by using the plurality of second editing tools, display the edited main modality media content.

In some embodiments, the plurality of second editing tools include a copying tool. The processing unit 120 is further configured to copy the main modality media content as main modality media content of a third media creation project in response to a triggering operation performed on the copying tool.

In some embodiments, the processing unit 120 is further configured to store the main modality media content and the target sub-modality media content of the first media creation project in a cloud storage file.

In some embodiments, the processing unit 120 is further configured to perform a target operation on at least one of the main modality media content and the target sub-modality media content in response to triggering of the target operation in an operation option, the target operation including a renaming operation, a deleting operation, a sharing operation, or a moving operation.

In some embodiments, the processing unit 120 is further configured to synchronize the target operation to the cloud storage file, so that the target operation is performed on the at least one piece of media content in the cloud storage file.

In some embodiments, the processing unit 120 is specifically configured to copy at least one of the main modality media content and the target sub-modality media content as main modality media content of a new media creation project in response to triggering of the copying operation.

In some embodiments, the processing unit 120 is further configured to post at least one of the main modality media content and the target sub-modality media content of the first media creation project to a third-party platform in response to a triggering operation performed on a posting option.

In some embodiments, the processing unit 120 is further configured to export at least one of the main modality media content and the target sub-modality media content of the first media creation project in response to a triggering operation performed on an export option.

It is to be understood that the apparatus embodiment and the method embodiment may correspond to each other, and for the similar description, reference may be made to the method embodiment. To avoid repetition, details are not described herein again. Specifically, the apparatus 10 shown in FIG. 11 may perform the foregoing method embodiment. In addition, the foregoing and other operations and/or functions of the modules in the apparatus 10 are respectively configured to implement the foregoing method embodiments. For brevity, details are not described herein again.

The apparatus in this embodiment of this application is described above from the perspective of functional modules with reference to the accompanying drawings. It is to be understood that the functional modules may be implemented in the form of hardware, or may be implemented by using an instruction in the form of software, and may further be implemented by using a combination of hardware and software modules. Specifically, the steps of the method embodiments in the embodiments of this application may be completed by using an integrated logic circuit of hardware in a processor and/or the instruction in the form of software. The steps of the method disclosed in combination with the embodiments of this application may be directly performed by a hardware decoding processor, or may be performed by using a combination of hardware and software modules in the decoding processor. In some embodiments, a software module may be located in a mature storage medium in the art, such as a random access memory (RAM), a flash memory, a read-only memory (ROM), a programmable ROM, an electrically erasable programmable memory, or a register. The storage medium is located in the memory, and a processor reads information in the memory and completes the steps in the foregoing method embodiment in combination with hardware of the processor.

FIG. 12 is a schematic block diagram of an electronic device according to an embodiment of this application. The electronic device may be the foregoing terminal device.

As shown in FIG. 12, the electronic device 40 may include
a memory 41 and a processor 42. The memory 41 is configured to store a computer program and transmit program code to the processor 42. In other words, the processor 42 may invoke the computer program from the memory 41, and run the computer program, to implement the method in the embodiments of this application.

For example, the processor 42 may be configured to perform the foregoing method embodiment based on an instruction in the computer program.

In some embodiments of this application, the processor 42 may include but is not limited to
a general-purpose processor, a digital signal processor (DSP), an application specific integrated circuit (ASIC), a field programmable gate array (FPGA), or another programmable logic device, a discrete gate or a transistor logic device, a discrete hardware component, or the like.

In some embodiments of this application, the memory 41 includes but is not limited to
a volatile memory and/or a non-volatile memory. The non-volatile memory may be a ROM, a programmable ROM (PROM), an erasable PROM (EPROM), an electrically EPROM (EEPROM), or a flash memory. The volatile memory may be a RAM that is used as an external cache. Through examples but not limitation, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

In some embodiments of this application, the computer program may be divided into one or more modules, and the one or more modules are stored in the memory 41 and executed by the processor 42 to perform the method provided in this application. The one or more modules may be a series of computer program instruction segments that can execute specific functions. The instruction segments are used for describing an execution process of the computer program in a video making device.

As shown in FIG. 12, the electronic device 40 may further include
a transceiver 43. The transceiver 43 may be connected to the processor 42 or the memory 41.

The processor 42 may control the transceiver 43 to communicate with another device. Specifically, the transceiver may transmit information or data to another device, or receive information or data transmitted by the another device. The transceiver 43 may include a transmitter and a receiver. The transceiver 43 may further include an antenna, and one or more antennas may be arranged.

It is to be understood that various components in the video making device are connected through a bus system. In addition to a data bus, the bus system further includes a power bus, a control bus, and a status signal bus.

This application further provides a computer storage medium, having a computer program stored thereon, the computer program, when executed by a computer, causing the computer to perform the method in the foregoing method embodiment. Alternatively, this embodiment of this application further provides a computer program product including an instruction, the instruction, when executed by a computer, causing the computer to perform the method in the foregoing method embodiment.

During implementation by using software, all or some of the embodiments may be implemented in the form of the computer program product. The computer program product includes one or more computer instructions. When the computer program instructions are loaded and executed on the computer, the processes or functions according to the embodiments of this application are all or partially generated. The computer may be a general-purpose computer, a dedicated computer, a computer network, or another programmable apparatus. The computer instruction may be stored in a computer-readable storage medium or may be transmitted from a computer-readable storage medium to another computer-readable storage medium. For example, the computer instruction may be transmitted from a website, a computer, a server, or a data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium accessible by a computer, or may be a data storage device such as a server or a data center integrated with one or more available media. The available medium may be a magnetic medium (for example, a floppy disk, a hard disk, or a magnetic tape), an optical medium (for example, a digital video disc (DVD)), a semiconductor medium (for example, a solid state disk (SSD)), or the like.

A person of ordinary skill in the art may be aware that, in combination with the examples described in the embodiments disclosed in this specification, modules and algorithm steps can be implemented by electronic hardware or a combination of computer software and electronic hardware. Whether the functions are executed by hardware or software depends on specific applications and design constraint conditions of the technical solutions. A person skilled in the art may use different methods to implement the described functions for each particular application, but it is not to be considered that such implementation goes beyond the scope of this application.

It is to be understood from several embodiments provided in this application that the disclosed system, apparatus, and method may be implemented in other manners. For example, the apparatus embodiments described above are merely exemplary. For example, division of modules is merely logical function division and may be other division manners during actual implementation. For example, a plurality of modules or components may be combined or integrated into another system, or some features may be omitted or not executed. In addition, the displayed or discussed mutual coupling or direct coupling or communication connection may be implemented by using some interfaces. The indirect coupling or communication connection between the apparatuses or modules may be electrical, mechanical, or in other forms.

The modules described as separate components may or may not be physically separated, and the components displayed as modules may or may not be physical modules, which may be located in one place or may be distributed on a plurality of network units. Some or all of the modules may be selected according to actual needs to implement the objectives of the solutions of the embodiments. For example, functional modules in the embodiments of this application may be integrated into one processing module, or the functional modules may exist alone physically, or two or more modules may be integrated into one module.

The foregoing descriptions are merely specific implementations of this application, but are not intended to limit the protection scope of this application. Any variation or replacement readily figured out by a person skilled in the art within the technical scope disclosed in this application falls within the protection scope of this application. Therefore, the protection scope of this application is subject to the protection scope of the claims.

What is claimed is:

1. A media content creation method, applied to a terminal device, the method comprising:
displaying a main modality editing interface;
generating main modality media content in response to an editing operation performed on the main modality editing interface;
converting the main modality media content to target sub-modality media content in response to a modality conversion operation; and
displaying the generated main modality media content and the target sub-modality media content.

2. The method according to claim 1, wherein the generating main modality media content in response to an editing operation performed on the main modality editing interface comprises:
generating the main modality media content in response to the editing operation performed on the main modality editing interface, and determining N sub-modalities corresponding to a main modality, the N sub-modalities being different from the main modality, N being a positive integer; and
displaying the main modality media content and icons of the N sub-modalities in a same creation container.

3. The method according to claim 2, wherein the modality conversion operation comprises a triggering operation performed on an icon of a target sub-modality, and the converting the main modality media content to target sub-modality media content in response to a modality conversion operation comprises:
converting the main modality media content to the target sub-modality media content in response to the triggering operation performed on the icon of the target sub-modality in the N sub-modalities; and
replacing the icon of the target sub-modality in the creation container with the target sub-modality media content.

4. The method according to claim 2, wherein the modality conversion operation is a triggering operation performed on a modality conversion option, and the converting the main modality media content to target sub-modality media content in response to a modality conversion operation comprises:
displaying the main modality editing interface in response to a selection operation performed on the main modality media content, the main modality editing interface comprising the modality conversion option;
displaying the icons of the N sub-modalities in response to the triggering operation performed on the modality conversion option;
converting the main modality media content to the target sub-modality media content and jumping to a sub-modality editing interface in response to a triggering operation performed on an icon of a target sub-modality in the N sub-modalities, the sub-modality editing interface comprising an editing completion option; and
replacing the icon of the target sub-modality in the creation container with the target sub-modality media content in response to a triggering operation performed on the editing completion option.

5. The method according to claim 1, wherein the generating main modality media content in response to an editing operation performed on the main modality editing interface comprises:
generating the main modality media content and a project file of the main modality media content in response to the editing operation performed on the main modality editing interface, the project file comprising a material referenced by the main modality media content and an accessible path of the material; and
the converting the main modality media content to target sub-modality media content in response to a modality conversion operation comprises:
converting the main modality media content to the target sub-modality media content based on the main modality media content and the project file in response to the modality conversion operation.

6. The method according to claim 2, wherein the displaying the main modality media content and icons of the N sub-modalities in a same creation container comprises:
displaying the main modality media content in a first area of the creation container, and displaying the icons of the N sub-modalities in a second area of the creation container, the first area being larger than the second area.

7. The method according to claim 1, further comprising:
displaying a sub-modality editing interface in response to a triggering operation performed on the target sub-modality media content, the sub-modality editing interface comprising a plurality of first editing tools; and
displaying, in response to editing of the target sub-modality media content by using the plurality of first editing tools, the edited target sub-modality media content.

8. The method according to claim 7, wherein the plurality of first editing tools comprise a creating tool, and the method further comprises:
creating the target sub-modality media content as main modality media content of a second media creation project in response to a triggering operation performed on the creating tool.

9. The method according to claim 1, further comprising:
displaying a main modality editing interface of the main modality media content in response to a triggering operation performed on the main modality media content, the main modality editing interface comprising a plurality of second editing tools; and
in response to editing of the main modality media content by using the plurality of second editing tools, displaying the edited main modality media content.

10. The method according to claim 9, wherein the plurality of second editing tools comprise a copying tool, and the method further comprises:
copying the main modality media content as main modality media content of a third media creation project in response to a triggering operation performed on the copying tool.

11. The method according to claim 1, further comprising:
storing main modality media content and target sub-modality media content of a first media creation project in a cloud storage file.

12. The method according to claim 1, further comprising:
performing a target operation on at least one of the main modality media content and the target sub-modality media content in response to triggering of the target operation in an operation option, the target operation comprising a renaming operation, a deleting operation, a sharing operation, or a moving operation.

13. The method according to claim 12, further comprising:
synchronizing the target operation to the cloud storage file, to perform the target operation on the at least one piece of media content in the cloud storage file.

14. The method according to claim 12, wherein the target operation is a copying operation, and the performing a target operation on at least one piece of the main modality media content and the target sub-modality media content in response to triggering of the target operation in an operation option comprises:
copying at least one piece of the main modality media content and the target sub-modality media content as main modality media content of a new media creation project in response to triggering of the copying operation.

15. The method according to claim 1, further comprising:
posting at least one piece of the main modality media content and the target sub-modality media content of the first media creation project to a third-party platform in response to a triggering operation performed on a posting option.

16. The method according to claim 1, further comprising:
exporting at least one piece of the main modality media content and the target sub-modality media content of the first media creation project in response to a triggering operation performed on an export option.

17. A media content creation apparatus, comprising:
at least one memory and at least one processor, the at least one memory being configured to store a computer program, and the at least one processor being configured to invoke and run the computer program stored in the at least one memory to perform:
displaying a main modality editing interface;
generating main modality media content in response to an editing operation performed on the main modality editing interface;
converting the main modality media content to target sub-modality media content in response to a modality conversion operation; and
displaying the generated main modality media content and the target sub-modality media content.

18. The apparatus according to claim 17, wherein the generating main modality media content in response to an editing operation performed on the main modality editing interface comprises:
generating the main modality media content in response to the editing operation performed on the main modality editing interface, and determining N sub-modalities corresponding to a main modality, the N sub-modalities being different from the main modality, N being a positive integer; and
displaying the main modality media content and icons of the N sub-modalities in a same creation container.

19. The apparatus according to claim 18, wherein the modality conversion operation comprises a triggering operation performed on an icon of a target sub-modality, and the converting the main modality media content to target sub-modality media content in response to a modality conversion operation comprises:
converting the main modality media content to the target sub-modality media content in response to the triggering operation performed on the icon of the target sub-modality in the N sub-modalities; and
replacing the icon of the target sub-modality in the creation container with the target sub-modality media content.

20. A non-transitory computer-readable storage medium, configured to store a computer program, the computer program, when being executed by at least one processor, causing the at least one processor to perform:
displaying a main modality editing interface;
generating main modality media content in response to an editing operation performed on the main modality editing interface;
converting the main modality media content to target sub-modality media content in response to a modality conversion operation; and
displaying the generated main modality media content and the target sub-modality media content.
